(19) United States
(12) Patent Application Publication
(10) Pub. No.: US 2009/0307416 A1
(43) Pub. Date: Dec. 10, 2009

(54) SSD WITH A CONTROLLER ACCELERATOR

(75) Inventors: JIANJUN LUO, Los Gatos, CA (US); JUL CHUAN LIANG, Laguna Niguel, CA (US); MINHORNG KO, San Jose, CA (US)

Correspondence Address: DUANE MORRIS LLP - Philadelphia;IP DEPARTMENT, 30 SOUTH 17TH STREET, PHILADELPHIA, PA, 19103-4196, US

(73) Assignee: Intitio Corporation, San Jose, CA (US)

(21) Appl. No.: 12/476,414

(22) Filed: Jun. 2, 2009

Related U.S. Application Data
(60) Provisional application No. 61/058,752, filed on Jun. 4, 2008.

(51) Int. Cl. G06F 12/00; G06F 12/06; G06F 12/02

(52) U.S. Cl. 711/103; 711/104; 711/E12.008; 711/E12.083

(57) ABSTRACT

In one embodiment, a data storage system includes a solid state data storage device and a memory controller in signal communication with the solid state data storage device. The memory controller includes a processor, a local memory, and an accelerator coupled between the processor and the local memory. The accelerator includes logic circuitry configured to perform data management for the local memory.

### CROSS-REFERENCE TO RELATED APPLICATIONS

This application claims priority benefit to U.S. Provisional Patent Application No. 61/058,752 filed Jun. 4, 2009, which is incorporated by reference herein in its entirety.

### FIELD OF DISCLOSURE

The disclosed system and method relate to memory storage devices. More specifically, the disclosed system and method relate to solid-state drives.

### BACKGROUND

Solid-state drives (SSD) are a form of data storage that use a solid-state memory to store data. Examples of solid state memory include static random access memory (SRAM), dynamic random access memory (DRAM), and flash memory. SSDs are less susceptible to mechanical failures compared to conventional hard disk drives because SSDs do not include as many moving parts as conventional disk drives, which store data on a rotating disk. Additionally, SSDs have a faster startup time than conventional hard disk drives because they do not require time for a disk to spin up to a particular speed in order for data to be written to or read from the disk.

An SSD may comprise a plurality of NAND flash memory cells or DRAM memory cells. NAND flash memory may be single-level cell (SLC) flash or multi-level cell (MLC) flash. SLC flash stores a single bit of data per cell, and MLC flash stores store two or more bits of data per cell. Accordingly, MLC flash has a higher density than that of SLC flash, and MLC flash is more commonly used in an SSD than SLC flash due to its lower price and higher capacity. However, MLC flash has a higher bit error rate (BER) compared to its less complex counterpart SLC flash. Accordingly, SLC flash is more reliable.

Flash memory has a finite number of erase-write cycles. A flash controller performs wear-leveling operations to prolong the life of flash memory. These wear-leveling operations spread out the read and write operations among the flash groups so that one flash group is not constantly being written to and erased. Additionally, the same flash controller coordinates the read, write, and erase cycles as well as perform error correction for the entire group of flash memory. For example, the controller loads firmware to calculate or translate a logical memory address provided by a host to a physical address within a flash storage. Additionally, when a controller copies data from one location to another in a RAM, the data is moved in minimal increments and not all at once. Consequently, these processes slow down the performance of a storage controller and the ability of a host to write data to or read data from the storage device.

Accordingly, an improved solid-state flash memory architecture is needed.

### SUMMARY

In some embodiments, a data storage system includes a solid state data storage device and a memory controller in signal communication with the solid state data storage device. The memory controller includes a processor, a local memory, and an accelerator coupled between the processor and the local memory. The accelerator includes logic circuitry configured to perform data management for the local memory.

In some embodiments, a data storage controller includes a processor, a local random access memory (RAM) and an accelerator. The processor is configured to be coupled to a solid state memory device. The accelerator is in signal communication with the processor and includes a plurality of logic gates configured to perform data management functions for the local RAM in response to receiving one or more signals from the processor.

In some embodiments, a solid state drive (SSD) includes a flash memory device, a random access memory (RAM), a processor, and an accelerator. The RAM is in data communication with the flash memory device. The processor is coupled to the flash memory device and the RAM. The processor is configured to manage data transfer from the flash memory device to a host device. The accelerator is coupled to the processor and the RAM. The accelerator includes logic circuitry configured to perform data management for the RAM.

### BRIEF DESCRIPTION OF THE DRAWINGS

FIG. 1 is a block diagram of one example of a data storage device in accordance with the present disclosure.

FIG. 2 is a block diagram of one example of a flash device.

FIG. 3 is a block diagram of one example of an accelerator configured to copy data from a first location to a second location within a RAM in accordance with the embodiment illustrated in FIG. 1.

FIG. 4 is a block diagram of one example of an accelerator configured to search for data within a RAM in accordance with the embodiment illustrated in FIG. 1.

FIG. 5A is a block diagram of one example of an accelerator configured to translate a logical address sent from a host to a physical location within a flash device in accordance with the embodiment shown in FIG. 1.

FIG. 5B is a block diagram of another example of an accelerator configured to translate a logical address sent from a host to a physical location within a flash device in accordance with the embodiment shown in FIG. 1.

### DETAILED DESCRIPTION

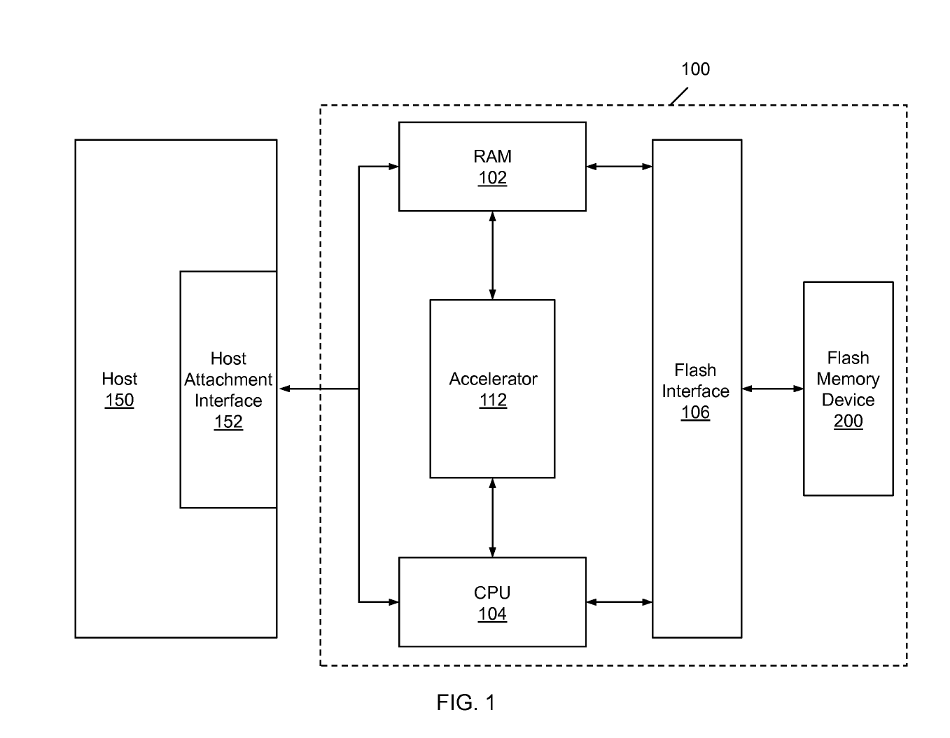

FIG. 1 illustrates one example of a data storage 100 connected to a host 150. As shown in FIG. 1, data storage 100 may be connected to the host 150 through a host attachment interface 152 such as a serial advanced technology attachment (SATA), a universal serial bus UBS connection, or other attachments. Host 150 may be a personal computer such as a laptop or desktop, a workstation, a server, or any device having a central processing unit (CPU). Additionally, host 150 may be configured to run any type of operating system including, but not limited to, Microsoft® Windows, Linux, UNIX, Mac OS X, FreeBSD®, and the like.

As shown in FIG. 1, data storage 100 includes a local random access memory (RAM) 102, a central processing unit (CPU) 104, an accelerator 112, a flash interface 106, and a flash device 200. CPU 104 may be a processor, microprocessor, microcontroller, or like device configured to manage data transfer between host 150 to flash device 200. CPU 104 is connected to host 150 through host attachment interface 152, to flash device 200 through flash interface 106, and to RAM 102. RAM 102 may be any type of random access memory such as, for example, static random access memory (SRAM) or dynamic random access memory (DRAM).

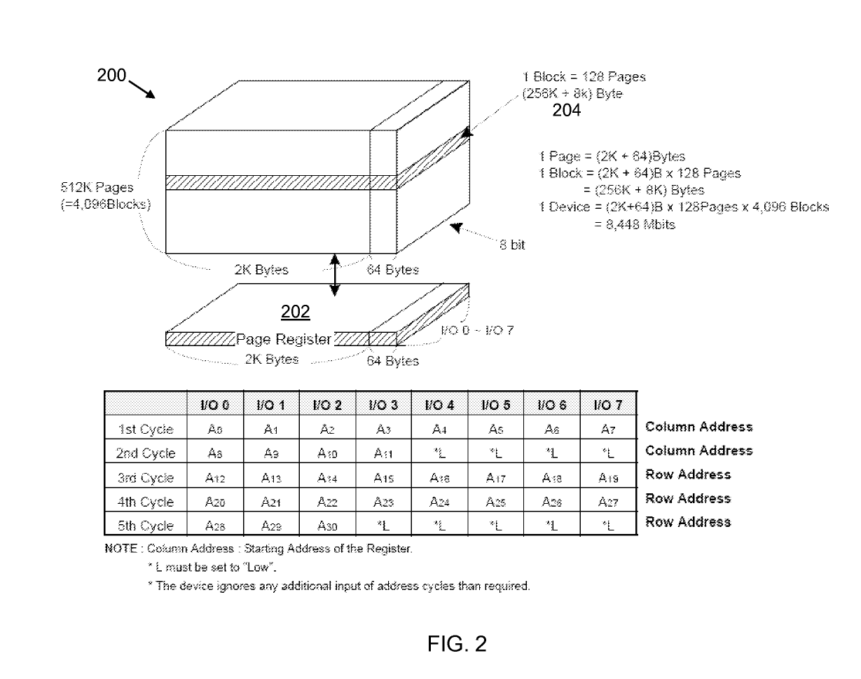

FIG. 2 illustrates one example of an architecture of the flash device 200 comprising 8,448 megabits. One skilled in the art will understand that flash device 200 may be configured with fewer or more bits depending upon the particular memory requirements of a system. As shown in FIG. 2, flash device 200 includes 512K pages 202 with each page including 2,064 bytes arranged in rows and columns. The pages 202 may be grouped into blocks 204 where each block includes 128 pages. In one embodiment, flash device 200 may have a minimal unit that is a byte such as a secure digital (SD) memory stick. In other embodiments, flash device 200 may have a minimal unit that is 512 bytes such as a USB flash drive. One skilled in the art will appreciate that flash device 200 may have other minimal units.

Controller accelerator 112 may be a logic circuit connected to the local RAM 102 and CPU 104. In some embodiments, accelerator 112 may include multiple modules each configured to perform a data management function that was previously performed by a conventional flash controller. Examples of data management functions that may be performed by accelerator 112 include, but are not limited to, data searching and copying in RAM 102 as well as translating storage addresses from a logical host format to a flash address format.

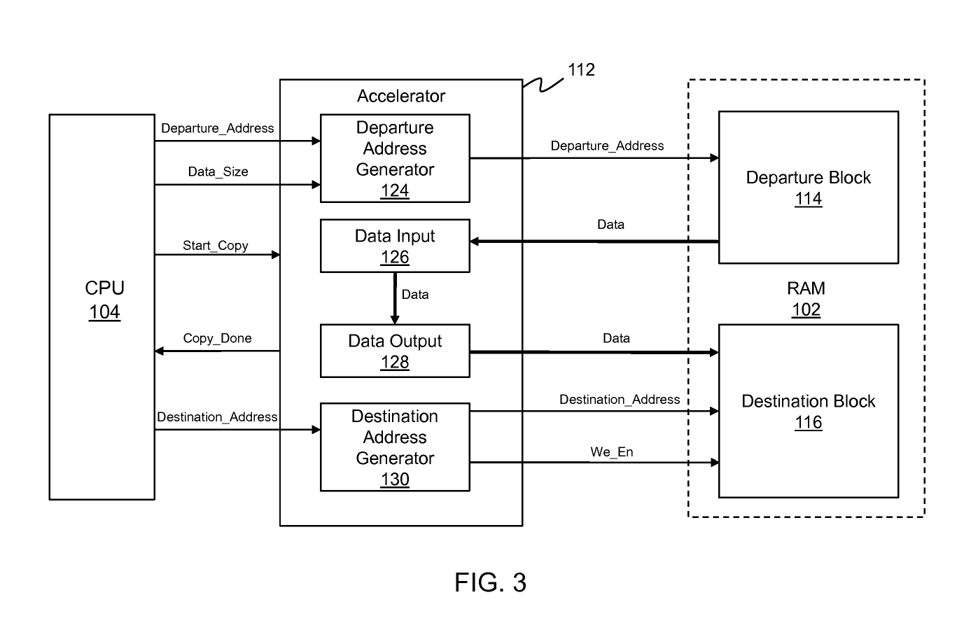

FIG. 3 is a block diagram illustration of one example of a controller accelerator 112 configured to copy data from a departure block 114 to a destination block 116 in RAM 102. As shown in FIG. 3, CPU 106 sends a Start_Copy signal along with a Departure_Address, a Destination_Address, and a Data_Size value to accelerator 112. With the Start_Copy signal high, data transfer is enabled. The Data_Size value identifies the amount of data that will be transferred. Controller accelerator 112 transmits the Departure_Address signal to departure block 114 and receives the data located at the departure address from the departure block 114. The data is received at a data input 126 of the accelerator 112 and the size of the data is determined. After reading the data from the departure block 114, the departure address generator 124 of the accelerator increments the Departure_Address value by the size of the data received from the departure block 114.

The data is then transferred to the destination block 116 through a data output 128 of the accelerator 112. A Destination_Address value is also transferred to the destination block 116 from the destination address generator 130 of the accelerator 112 while the We_En signal is toggling. After the data is written to the destination block 116, the destination address generator increments the Destination_Address value based on the size of the data transferred from the accelerator 112 to the destination block 116. This process continues until the total amount of data transferred equals the Data_Size value received from the CPU 106.

The controller accelerator 112 stops toggling the We_En signal and sends a Copy_Done signal to CPU 104. In this manner, controller accelerator 112 facilitates data copying within RAM 102. Since accelerator 112 is managing the copying of data within RAM 102, CPU 104 is free to perform other functions thereby improving the performance of data storage 100. Additionally, operations that may have taken 20 clock cycles in conventional data systems, for example, may only take a few clock cycles.

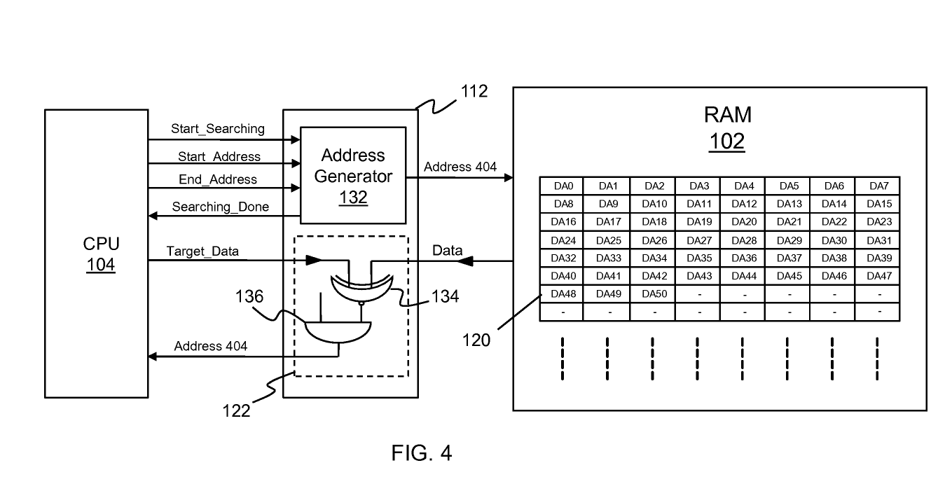

FIG. 4 illustrates one example of the controller accelerator 112 configured to perform data searching in RAM 102. As shown in FIG. 3, CPU 104 transmits Start_Searching, Start_Address, End_Address, and Target_Data signals to controller accelerator 112. Using the signals received from CPU 104, controller accelerator 112 generates and transmits an address to RAM 102. The address transmitted to RAM 102 may be an address value between the Start_Address and the End_Address received by controller accelerator 112 from CPU 104. RAM 102 transmits data 120 to accelerator 112, which will compare the data address of the data received from RAM 102 with the Target_Data value received from CPU 104 at a comparison logic block 122.

As shown in FIG. 4, the comparison logic block 122 may include an exclusive OR gate 134 that receives the Target_Data value and the data from the memory 102 as inputs. The output of the exclusive OR gate 134 may be used as an input to an AND gate 136, which also receives the output of the address generator 132, e.g., Address 404. Accordingly, if the target Target_Data value matches the data received from the memory 102, then the Address 404 at which the data is located in the memory 102 is transferred to the CPU 104. However, if the data received from RAM 102 does not match the Target_Data value, then accelerator 112 will request data with a higher or lower address from RAM 102 and perform another comparison with the retrieved data and the Target_Data value. Controller accelerator 112 may repeat the data searching until the data retrieved from RAM 102 matches the Target_Data value.

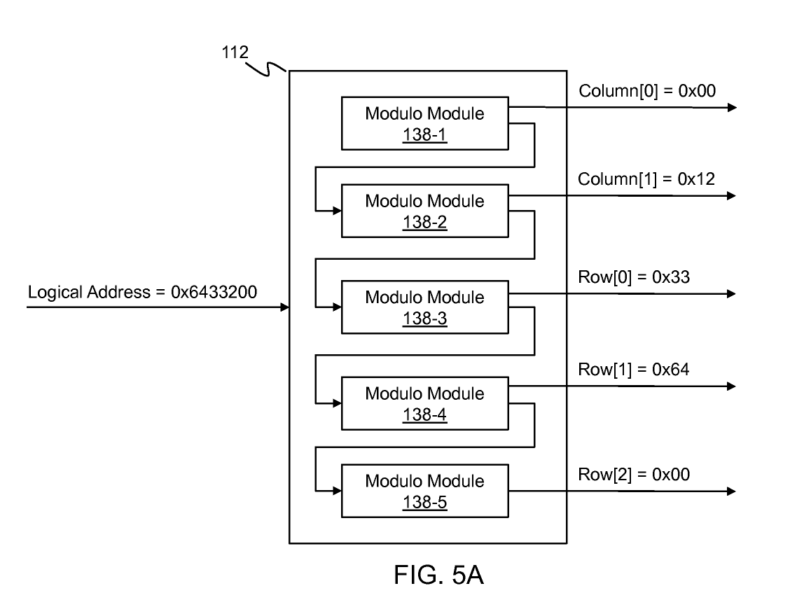

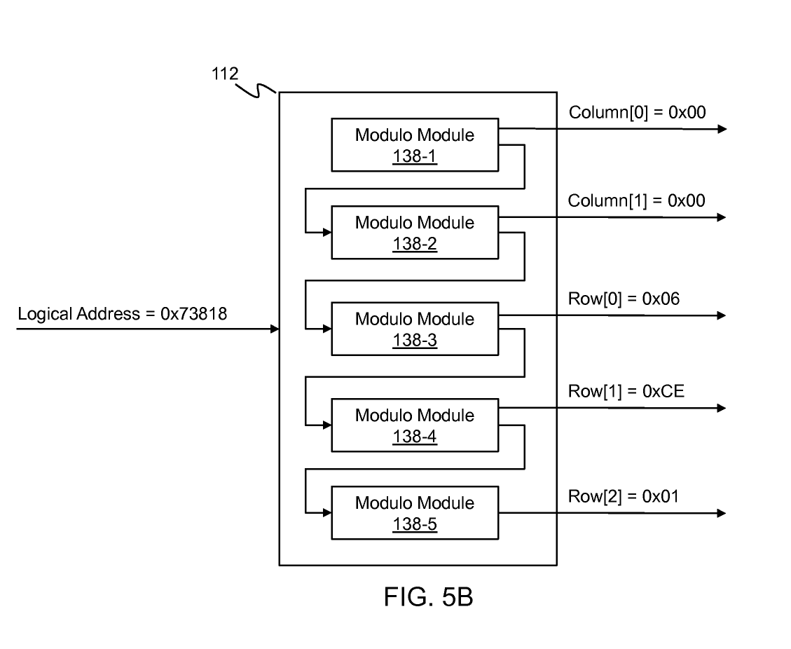

FIGS. 5A and 5B illustrate examples of the controller accelerator 112 configured to translate a logical address provided by a host 150 to a physical memory location within the flash device 200. As illustrated in FIGS. 5A and 5B, controller accelerator 112 may include a plurality of modules 138-1 through 138-5 configured to perform modulo operations. The controller accelerator 112 shown in FIG. 5A is configured to translate a logical address provided by host 150 to a physical address within flash device 200. Flash device 200 has a sector with 512 bytes as its smallest unit. The controller accelerator 112 shown in 5B is configured to translate the host address to a memory location, e.g., the column and row location in the flash device 200 having a byte as its smallest unit. Referring to FIG. 5B for example, if host 150 provides a logical storage location of 0x6433200 to accelerator 112, then the controller accelerator 112 may be configured to automatically derive the physical storage location as shown in Table 1, below:

TABLE 1

| A0 | A1 | A2 | A3 | A4 | A5 | A6 | A7 | A8 | A9 | A10 | A11 |
|---|---|---|---|---|---|---|---|---|---|---|---|
| 0 | 0 | 0 | 0 | 0 | 0 | 0 | 0 | 0 | 1 | 0 | 0 |

| A12 | A13 | A14 | A15 | A16 | A17 | A18 | A19 | A20 | A21 | A22 | A23 |
|---|---|---|---|---|---|---|---|---|---|---|---|
| 0 | 1 | 1 | 0 | 0 | 1 | 1 | 0 | 0 | 0 | 0 | 1 |

| A24 | A25 | A26 | A27 | A28 | A29 | A30 |
|---|---|---|---|---|---|---|
| 0 | 0 | 1 | 1 | 0 | 0 | 0 |

Where,
A0 to A8 represents 511 bytes;
A9 to A11 represents the number of 512 bytes;
A12 to A17 represents the number of pages; and
A18 to A29 represents the number of blocks

The addition of a controller accelerator 112 configured with logic circuitry that may translate memory addresses provided from a host 150 to a physical address location within a flash device 200 reduces the amount of processing that must be performed by CPU 104. Reducing the amount of processing needed to be performed by CPU 104 enhances the overall performance of storage device 100 including faster read, copy, and write times.

Although the invention has been described in terms of exemplary embodiments, it is not limited thereto. Rather, the appended claims should be construed broadly, to include other variants and embodiments of the invention, which may be made by those skilled in the art without departing from the scope and range of equivalents of the invention.

What is claimed is:

1. A data storage system, comprising:
a solid state data storage device; and
a memory controller in signal communication with the solid state data storage device, the memory controller including:
a processor;
a local memory; and
an accelerator coupled between the processor and the local memory, the accelerator including logic circuitry configured to perform data management for the local memory.

2. The data storage system of claim 1, wherein the local memory is a random access memory (RAM).

3. The data storage system of claim 2, wherein the solid state data storage is a flash memory device including a plurality of flash memory units in data communication with the random access memory (RAM) and the processor.

4. The data storage of claim 1, wherein the accelerator is configured to perform data searching in the local memory in response to receiving a signal from the processor.

5. The data storage of claim 1, wherein the accelerator is configured to perform data copying in the local memory in response to receiving a signal from the processor.

6. The data storage of claim 1, wherein the accelerator is configured to translate a data storage address from a logical host format to a flash address format.

7. The data storage of claim 1, wherein the accelerator includes a comparison module including an exclusive XOR gate, the comparison module configured to compare data received from the local memory with reference data received from the processor.

8. A data storage controller, comprising:
a processor configured to be coupled to a solid state memory device;
a local random access memory (RAM); and
an accelerator in signal communication with the processor, the accelerator including a plurality of logic gates configured to perform data management functions for the local RAM in response to receiving one or more signals from the processor.

9. The data storage controller of claim 8, wherein the accelerator is configured to perform data searching in the local RAM in response to receiving a signal from the processor.

10. The data storage controller of claim 8, wherein the accelerator is configured to perform data copying in the local RAM in response to receiving a signal from the processor.

11. The data storage controller of claim 8, wherein the accelerator is configured to translate a memory address from a logical host format to a flash address format.

12. The data storage controller of claim 8, wherein the accelerator includes a comparison module including an XOR gate for comparing data received from the local RAM with reference data received from the processor.

13. A solid state drive (SSD), comprising:
a flash memory device;
a random access memory (RAM) in data communication with the flash memory device;
a processor coupled to the flash memory device and the RAM, the processor configured to manage data transfer from the flash memory device to a host device; and
an accelerator coupled to the processor and the RAM, the accelerator including logic circuitry configured to perform data management for the RAM.

14. The SSD of claim 13, wherein the accelerator is configured to perform data searching in the RAM in response to receiving a signal from the processor.

15. The SSD of claim 13, wherein the accelerator is configured to perform data copying in the RAM in response to receiving a signal from the processor.

16. The SSD of claim 13, wherein the accelerator is configured to translate a data storage address from a logical host format to a flash address format.

17. The SSD of claim 13, wherein the accelerator includes a comparison module configured to compare data received from the RAM with reference data received from the processor.
